(19) United States
(12) Patent Application Publication
(10) Pub. No.: US 2008/0016760 A1
(43) Pub. Date: Jan. 24, 2008

(54) FLUID SEVERED PLANT ROOT SYSTEM TRANSPLANTATION

(76) Inventor: James Allen Dill, Henderson, NV (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/458,346

(22) Filed: Jul. 18, 2006

(51) Int. Cl. A01G 13/02

(52) U.S. Cl. 47/32.8

(57) ABSTRACT

A root ball is sculpted from a plant's root system and its surrounding soil using high pressure water ejected from a handheld wand to severe roots of the root system. Mud being formed is simultaneously vacuumed with another handheld wand to form a void between the root ball and the soil surrounding the root ball. The root ball can be wrapped or box for transportation of the plant to another location at which the plant will be transplanted. Positive and negative pressure sources, respectively for the high pressure water and the vacuuming can be mounted on a land vehicle for transportation to plants that are to be prepared for transplantation.

### TECHNICAL FIELD

The present invention relates generally to a plant, and is more particularly related to the transplanting of a plant.

### BACKGROUND

With remodeling or new construction of a residential or commercial building, there may also be a demand for landscaping. Rather than planting young, immature plants and trees at the construction lot, a landscape architect may design the lot plan to immediately include mature landscaping. Such a design necessitates that mature plant material be transplanted to the construction lot. This mature plant material may be one or more relatively large and mature trees, scrubs, and/or plants that must be removed from one location, be transported to the lot, and then be transplanted to at the lot.

A mature plant material can be removed from where it is growing for transplanting to another location using a variety of methods. To do so, while limiting damage to the health of the plant material, a portion of the root system is cut away so as to leave the remainder of the root system in the shape of a ‘root ball’. A root ball is a clump consisting of the main roots of the plant material with its soil (or other growing medium) clinging to the main roots after the plant material has been field-harvested. Generally deciduous trees require a nine inch root ball for each inch of trunk caliper, an industry-standardized unit of measurement for determining tree size by trunk diameter six inches above natural soil elevation. Evergreens require an eight inch root ball for each inch of trunk caliper. Palm trees and shrubs have varying size requirements for their root balls for each inch of trunk caliper, depending upon the type of thereof that is to be transplanted. An arbor culturist, such as an arborist, a tree surgeon, or a forestry consultant, may prescribe a particular root ball size and topography for a particular variety of plant material that is to be transplanted from one environment and location to a different environment and location.

A tree spade is a specialized piece of motorized equipment that is used dig and transport plant material, typically trees, for transplant. Tree spades come in a variety of sizes appropriate to different sizes and species of trees. In use, several blades of a tree spade are placed in a circular pattern so as to encircle the trunk of a tree that is to be transplanted. The blades are then driven into the soil surrounding the truck, typically by hydraulic power. As the blades penetrate into the soil around the tree truck, a root ball having a conical shape of decreasing size is formed as individual roots of the tree are abraded, snapped, torn, broken, and severed by the blades.

Once the root ball is formed, the tree with its root system wholly contained in the newly formed conical root ball can then be lifted out of the ground for transplant elsewhere. Prior to or after such removal from the ground, and depending upon the type and variety of the tree being transplanted, it may be desirable to box, wrap or otherwise contain the root ball within a flexible and/or rigid enclosure using a material that prevents loss of soil while maintaining the shape and size of the root ball. These enclosures can be, for instance, a plastic planting container, a wrapping with burlap stock, etc. The wrapping of the root ball can reduce transpiration, that is a loss of water vapor from the remaining root system in the root ball. Also, the truck of the tree can be encircled with a tree wrap, which is a temporary material to protect trunk of recently transplanted trees.

Despite its dependability, the tree spade comes with several built-in liabilities and has numerous limitations that prevents its use from being practical in many circumstances. For example, the tree spade can damage a plant's root system well beyond where the blades of the tree spade are applied to the plant's root system. This because pressure generated by the blade's blunt force to the individual roots can permeate throughout the plant's root system, thereby doing extensive structural damage to the plant's root system.

A tree spade can particularly aggravate transplant shock to a plant, so as have a large adverse impact of the digging, relocating and replanting on the plant's overall health and the length of time until it resumes normal growth. This is particularly the case for larger plant material as evidenced by wilting or leaf drop. Larger plant material are typically immediately impacted by a new environment. As such, these larger plant materials will be significantly affected by a relocation, and will have a delayed length of time for the relocated plant material to become accustomed to its new location so as to resume normal growth after the moisture and heat extremes of an environmental stress after installation or transplanting.

A root ball that is formed by the tree spade is typically limited in shape to a basic conical topography, thus preventing use of the tree spade where a tree ball of conical shape is not practical. A conical shaped root ball typically cannot be formed where the plant that is to be transplanted is growing up against a street, a curb, a building, or another structure that is impractical to move. A tree spade cannot be used to remove an elongate shrub intact, such as a shrub that is 6 yards long by 2 or 3 yards wide or otherwise has a generally rectangular cross section that is significantly longer than its width.

The tree spade may not be useful when a plant's root system is in close proximity to, or has grown so as to be entangled within, buried utilities such as gas lines, wires, and cables. The cutting of the tree spade's blades into the soil around the plant may do damage to the buried utilities. As such, removal of plants in this circumstance is not practical with the tree spade. The tree spade may not be useful when a plant's canopy is in close proximity to overhead utilities such as power lines, wires, and cables. The bulky size and electrical conductively of the tree spade by make its use impractical near overhead utilities. As such, removal of plants in such circumstances may not be practical or safe with the tree spade.

The tree spade can weigh several tons, thereby making a large environmental impact upon an area surrounding a plant to be removed when the tree spade cannot be positioned upon an asphalt or concrete surface such as a street or pad. The bulky size of the tree spade also limits its practical operational environment for tree removal only to the most ideal conditions that do not risk damage to expensive the surrounding structures and to the plants, trees, and scrubs. As such, many less than ideal operational environments for plant removal necessitate that a tree spade cannot be used, and the revenue otherwise possible from a transplanted plant cannot be realized because the plant cannot practically be removed and must be left in place.

It would be an advance in the art to provide methods and systems to prepare plants, including trees and shrubs, for transplantation without the foregoing problems known to tree spades.

### SUMMARY

Method and systems are disclose to sculpt a root ball from a root system of a plant and surrounding soil using a fluid under pressure to severe roots of the root system. The fluid under pressure is ejected from a nozzle at the end of a manually directed wand. With the sculpting, soil adjacent the root ball being sculpted can be removed such as by vacuuming using an intake at the end of a manually directed wand. The vacuuming can be intermittent, continuous, or both with the sculpting. The vacuuming forms a void between the root ball being sculpted and the soil surrounding the root ball. The fluid can be a liquid and/or a gas, and the vacuuming can be slurry formed while sculpting the root ball, where the slurry is formed by the liquid disrupting the surrounding soil of the root system. The liquid can be water with or without and an additive entrained therein, such as a solid material, a root cauterizing agent, a plant nutrient, a fertilizer, and combinations thereof Alternatively, the fluid can be a gas such as air.

### BRIEF DESCRIPTION OF THE DRAWINGS

FIGS. 1a-1a depict, in one implementation of an inventive method and system, before and after block level diagrams of the soil surrounding a plant (e.g.; a tree) being disrupted by a fluid under pressure that also severs roots in the root system of the plant, while a vacuum source extracts the disrupted soil;

FIG. 2 depicts, in another implementation of an inventive method and system for fluid severed plant root system transplantation, a mount for placement on a land vehicle, the mount having thereon positive and negative pressure sources respectively in fluid communication with a manually operated wand for application to the soil surrounding a plant (e.g.; a tree) to respectively disrupt soil and sever roots in the root system of the plant, while vacuum extracting the disrupted soil;

FIGS. 3a and 3c respectively depict a top planar view and a front elevational cross sectional view of a plant, and FIGS. 3b and 3d respectively depict the top planar view and the front elevational cross sectional view of the plant having a root ball formed thereon after being subjected to an implementation of the inventive fluid severed plant root system transplantation system and method;

FIGS. 4a and 4c respectively depict a top planar view and a front elevational cross sectional view of a plant, and FIGS. 4b and 4d respectively depict the top planar view and the front elevational cross sectional view of the plant having a root ball formed thereon after being subjected to yet another implementation of the inventive fluid severed plant root system transplantation system and method;

FIGS. 5a and 5c respectively depict a top planar view and a front elevational cross sectional view of an elongate shrub, and FIGS. 5b and 5d respectively depict the top planar view and the front elevational cross sectional view of the elongate shrub having a root ball formed thereon after being subjected to still another implementation of the inventive fluid severed plant root system transplantation system and method;

FIGS. 6a-6d depict respective front elevational cross sectional views of a plant and its root ball after being subjected to respective implementations of the inventive fluid severed plant root system transplantation system and method; and

FIG. 6e depicts a front elevational cross sectional view of an elongate shrub its root ball after being subjected to a still further implementation of the inventive fluid severed plant root system transplantation system and method.

### DESCRIPTION

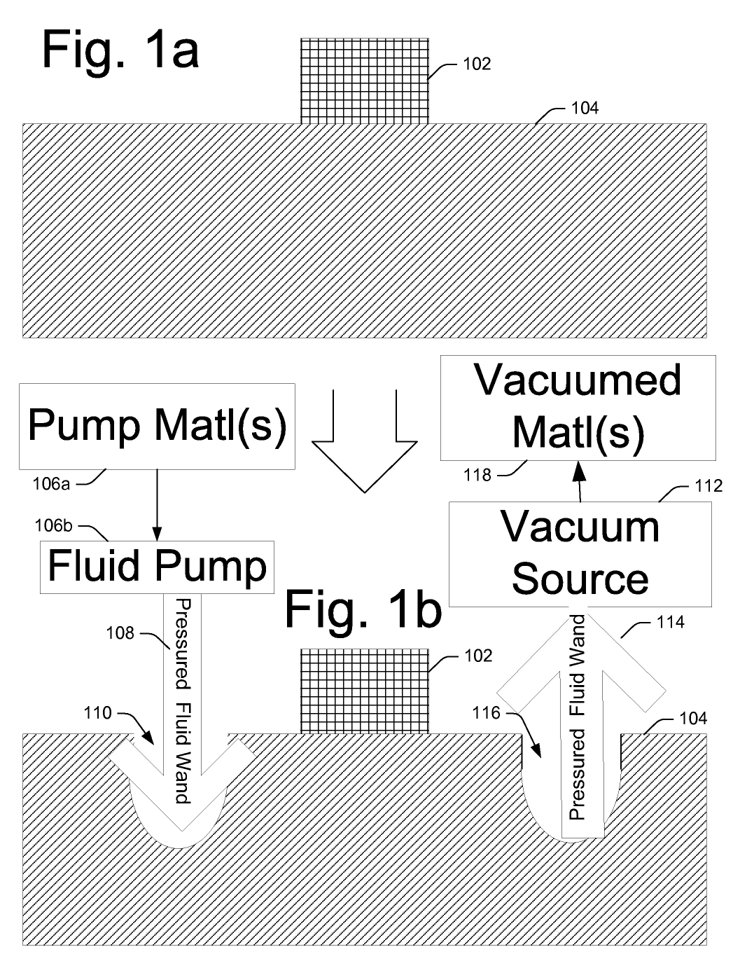

FIG. 1a depict a before block level diagram of a portion of a plant 102 projecting above and into soil 104 that surrounds plant 102. Note that the plant's foliage is not shown. As such, if plant 102 were a tree, the tree's canopy is not shown. In the other Figures, the canopy or foliage of each other plant is not shown, other than were indicated. A fluid pump 106b develops positive pressure for pumping pump material(s) 106a. The pump materials includes a fluid such as air and/or water. For instance, box 106a can be, at least in part, a water holding tank. The box 106a can also include containers to feed other pump materials to fluid pump 106b, such as containers to hold abrasives, plant nutrients, fertilizer, root cauterizing agents, etc. The fluid with or without entrained pump material(s) move through pressured fluid wand 108 into soil 104 to cause a soil disruption zone 110. The pumped fluid and materials entrained therein also sever roots in the root system of the plant 102.

A vacuum source 112 is in fluid communication with a pressured fluid wand 114 to extract parts of the severed roots, the disrupted soil, and slurry formed by the fluid and the soil—thereby creating a trench 116. The vacuuming by the wand 114 moves the vacuumed materials into the box seen at reference numeral 118 which can be the ambient, a slurry holding tank, etc.

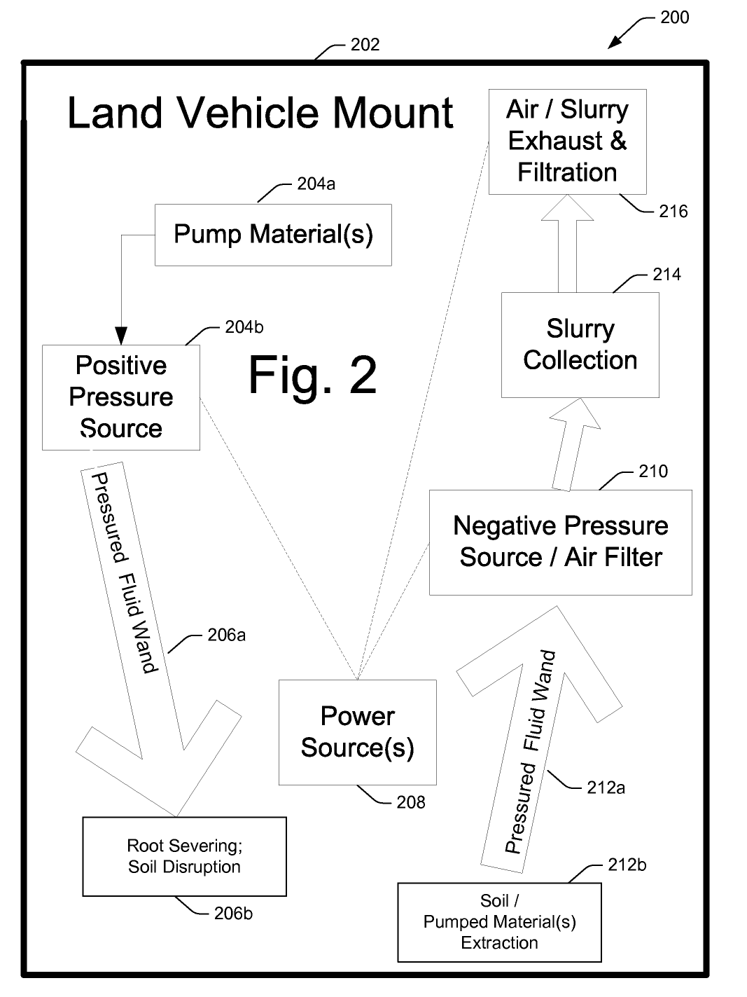

FIG. 2 depicts at 200 a mount 202 for placement on a land vehicle. The land vehicle can be used to transport the depicted transplantation equipment to the place where the plant to be transplanted is growing. The mount 202, which can be one or more temporary of permanent platforms, includes thereon both positive and negative pressure sources 204b, 210 respectively in fluid communication with a manually operated wand 206a, 212a for application to the soil 206b surrounding a plant (e.g.; a tree) to respectively disrupt soil and sever roots at zone 206b in the root system of the plant, while vacuum extracting the disrupted soil at zone 212b. One or more power sources 208 provide power to those components needing the same. Air filtration functionalities may be included with the positive and negative pressure sources 204b, 210. Positive pressure source 204b develops positive pressure for pumping pump material(s) 204a, including fluid such as air and/or water, and one or more solid materials entrained therein.

Negative pressure source 210 receives through a pressurized fluid wand 212a vacuumed material 212b for storage in a slurry collection zone 214 from which exhaust of the fluid and/or filtration thereof can be performed at box 216. In particular, slurry collected at box 214 by vacuuming can again be pumped using functionality in box 216 so as to return the slurry back into the hole using the same or a different wand (not shown) from which the plant and its root ball had been removed. Filtration of rocks and other debris can be performed both before the slurry enters box 214 as the slurry is leaving box 214. Alternatively, the box 216 might simply be an opening to box 214 to dump there from the slurry using merely a gravity feed.

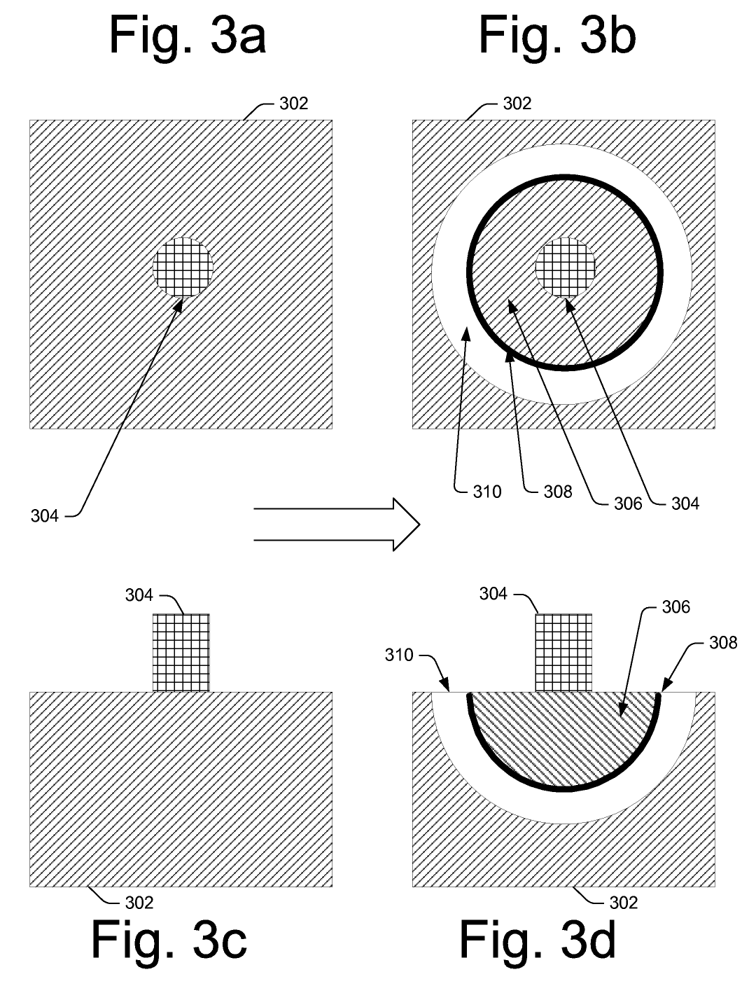

FIGS. 3a and 3c respectively depict a top planar view and a front elevational cross sectional view of a plant 304 and its surrounding soil 302. After being subjected to an implementation of the inventive fluid severed plant root system transplantation system and method, the plant 304 is seen in FIGS. 3b and 3d to respectively depict the top planar view and the front elevational cross sectional view of the plant 304 having a root ball 306 formed thereon. Root ball 306 can be sculpted using a hand held wand that ejects a fluid under pressure so as to disrupt soil 302 and sever roots in the root system of plant 304. A trench 310 separates the remaining soil 302 from root ball 306. Trench 310 can be formed by removing soil 302 and severed roots (not shown) as the soil 302 as being disrupted by the fluid under positive pressure. One such removal can be made by a complete or partial industrial vacuuming process so as to progressively form trench 310 until root ball 306 has been substantially separated from soil 302. Optionally, root ball 306 can be fully or partially boxed, wrapped, or enclosed using a structure 308. As depicted in FIG. 3d, plant 304 is being lifted above soil 302.

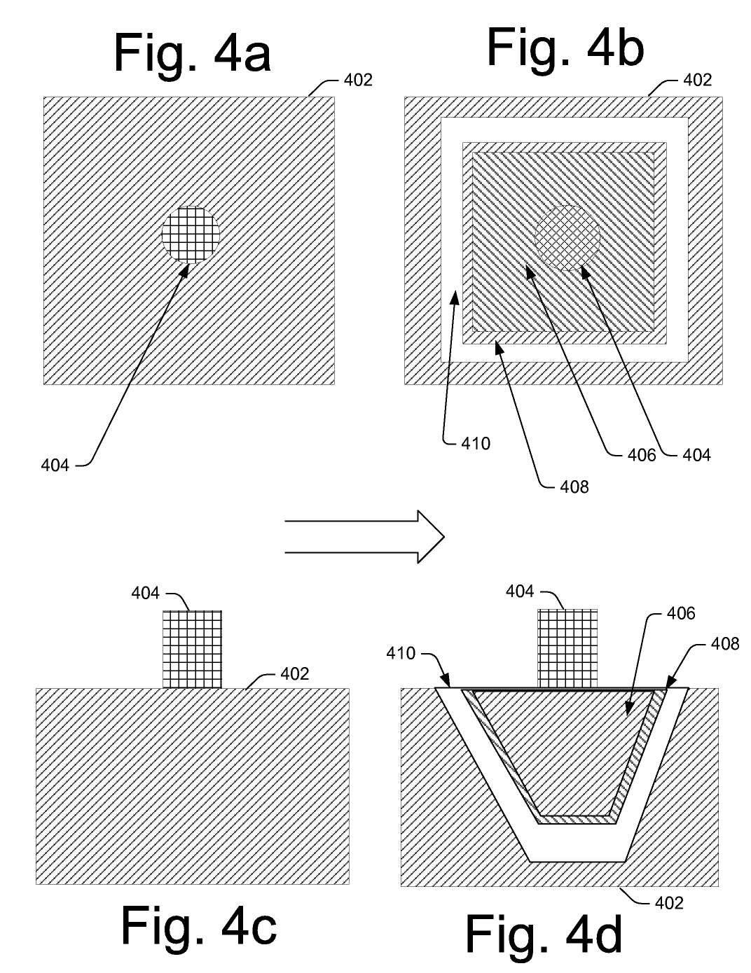

FIGS. 4a and 4c respectively depict a top planar view and a front elevational cross sectional view of a plant 404 and its surrounding soil 402. After being subjected to an implementation of the inventive fluid severed plant root system transplantation system and method, the plant 404 is seen in FIGS. 4b and 4d to respectively depict the top planar view and the front elevational cross sectional view of the plant 404 having a root ball 406 formed thereon. Root ball 406 can be sculpted using a hand held wand that ejects a fluid under pressure so as to disrupt soil 402 and sever roots in the root system of plant 404. A trench 410 separates the remaining soil 402 from root ball 406. Trench 410 can be formed by removing soil 402 and severed roots (not shown) as the soil 402 as being disrupted by the fluid under positive pressure. One such removal can be made by a complete or partial industrial vacuuming process so as to progressively form trench 410 until root ball 406 has been substantially separated from soil 402. Optionally, root ball 406 can be fully or partially boxed, wrapped, or enclosed using a structure 408. As depicted in FIG. 4d, plant 404 is being lifted above soil 402.

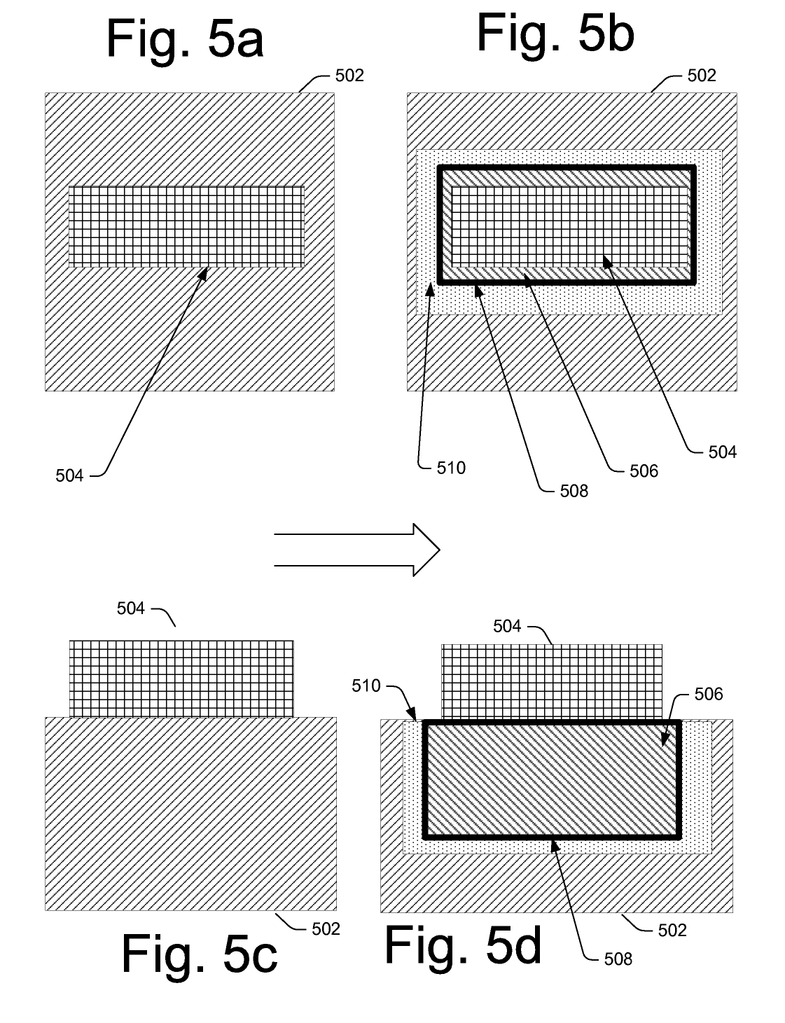

FIGS. 5a and 5c respectively depict a top planar view and a front elevational cross sectional view of an elongate shrub 504 planted with soil 502. FIGS. 5b and 5d respectively depict the top planar view and the front elevational cross sectional view of the elongate shrub 504 having a root ball 506 formed thereon after being subjected to a process of fluid severing roots of the shrub's root system so as to form there from the root ball 506 from the surrounding soil 504. Root ball 506 can be sculpted using a hand held wand that ejects a fluid under pressure so as to disrupt soil 502 and sever roots in the root system of shrub 504. A trench 510 separates the remaining soil 502 from root ball 506. Trench 510 can be formed by removing soil 502 and severed roots (not shown) as the soil 502 as being disrupted by the fluid under positive pressure. One such removal can be made by a complete or partial industrial vacuuming process so as to progressively form trench 510 until root ball 506 has been substantially separated from soil 502. Optionally, root ball 506 can be fully or partially boxed, wrapped, or enclosed using a structure 508. As depicted in FIG. 5d, shrub 504 with its root ball 506 is being lifted above soil 502, for instance, by placing one or more straps and/or platforms (not shown) below root ball 506 for support and to serve as a base to support the same as it is being lifted out of trench 510.

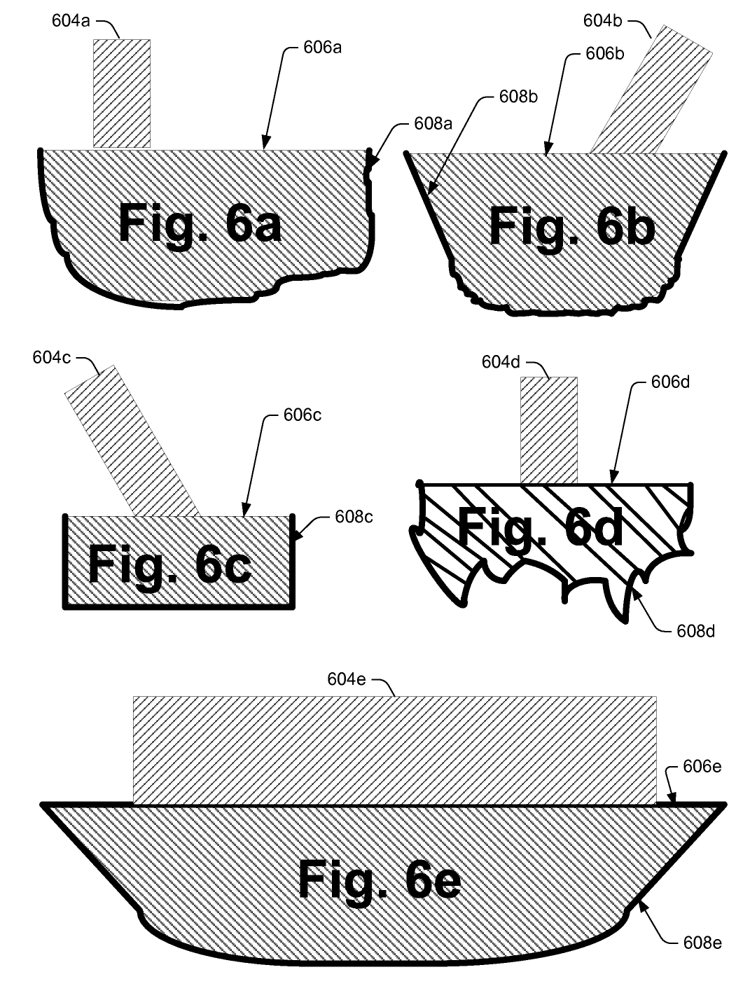

FIGS. 6a-6e depict respective front elevational cross sectional views of a plant 604a-e and its root ball 608a-e that has been sculpted from surrounding soils 606a-e. The root ball 608a-e has been sculpted by a process of severing the roots of a root system of the plant 604a-e with a fluid under pressure. The severed roots and resultant disrupted soil can be progressively removed away from the root ball 608a-e, such as by an industrial vacuuming process. A hand held wand ejecting therefrom a fluid under a positive pressure can be used to form root balls 608a-e in varied topography, making the hand held wand a tool of significant versatility for transplanting plants. Once the root ball has been substantially formed, plant 604a-e can be removed from where it has been growing. Before, during or after such removal, the root ball 306a-e can be fully or partially boxed, wrapped, or enclosed using a structure 608a-e. Structure 608a-e can serve a myriad of purposes, including preventing a loss of moisture from plant 604a-e through the root ball 306a-e, lending structural support to the root ball 306a-e, serving as a permanent or semi-permanent container or planter for plant 604a-e, etc. The plant 604e is a shrub having a length significantly greater than the width thereof.

FIGS. 6a-6c demonstrate the versatility of the handheld wand used to sculpt the root ball of virtually any desired topology. In the depicted examples, the portion of the plant 604a-c that projects about the ground need not be centered with respect to the root ball 608a-c. Also, the portion of the plant 604a-c that project about the ground need not be normal or perpendicular with respect to the ground. Moreover, the plant can be close to near by above and/or below the ground object(s) and the root ball can still be sculpted to a desired topology while avoiding damage or contact with the near by above or below the ground object(s).

A fluid, such as one or more gases and/or liquids, can be used to sever the roots in a root system of a plant so as to form a root ball. With fluid severing of the tree's root system, a root ball can be sculpted to a precise shape and topography, while keeping the severing forces of the fluid away from undesirable areas, avoiding easily damaged surfaces, while cutting with the fluid only to a predetermined depth. For instance, one inventive method uses a high pressure jet of water to cut the roots. The pressure to do so depends upon the plant and the environment of preparation of the plant for transplantation. For instance, when water is the fluid, the pressure can be as low as one thousand pounds per square inch (1,000 psi) 10,000 psi using a water flow rare of about twelve gallons per minute (12 gpm). Higher water pressures can also be used in a range of 12,000-15,000 psi with a 60 gpm flow to 36,000 psi and a 72 gpm flow. To accomplish this high flow and pressure, two water hoses can be combined together to double the flow pressure. Other pressures and flow can also be used, including a pressure of 36,000 psi at 5 to 14 gpm flow. The flow rate may be changed and depends on whether the application calls for the marrying of two pumps and their respective hoses.

Fluid severing of the tree's root system may be desirable because of the proximity of the root system to buried utilities such as gas lines, wires, and cables. The cutting with water jets at varying pressures and flows, when combines with industrial vacuuming also for the careful removal of soil and exposure of the buried utilities, thereby avoiding damage to the buried utilities, while making possible the removal of trees that otherwise would not be possible with a tree spade.

Shrubs can also be subjected to fluid severing of roots to form a root ball. A shrub, for instance, may appear from an overhead view to assume the appearance of a cross word puzzle having row and columns. Each row and column might be 6 yards long and 2 to 3 yards wide, with each approximately being rectangular in cross section. The roots of the root system of the shrub, which can actually be composed of one or more plants, can be severed with a fluid under pressure to sculpt therefrom a root ball thereunder. As such, the resultant sculpted root ball of the scrub for transplantation will assume an elongate shape. By way of example, see FIGS. 5a-5b and 6e. In such implementations, the shrub for transplantation may have a sculpted root ball that has a two dimensional cross sectional shape of an oval, a semicircle or an ellipse along a first axis, and a cross section of an elongate solid tube or semi-cylinder along a second axis perpendicular to the first axis. In three dimensions, for instance, the appearance of the shrub's root ball might roughly approximate that of a semi-cylinder.

Fluid severing of the plant's root system, be it a tree or a shrub, may be desirable because of its low impact upon the root system as compared to the process of transplantation using a tree spade. In the case of a plant that is under stress due to drought, too much water or too much heat or sun, transplanting with fluid severing of the plant's root system is more gentile on the roots as compared to a tree spade. Moreover, severing the root system with water, without or without entrained nutrients, may be even more beneficial to the stressed plant's health.

The plant's health is also benefited by fluid severing its roots to sculpt its root ball when the plant is to be imported from another region. This is particularly true for plants that are already under stress or are being imported to a significantly different environment, where its survival depends on a similar climate or upon the ability of the imported plant to adapt to the new climate. In addition to entrained nutrients, an additive can be included in the cutting to fluid that will cauterize the severed roots, thereby limiting the loss of moisture from the remainder of the root system in the root ball.

In different implementation, the inventive system and method can use hand held positive and negative pressure wands. This hand held equipment, typically wands of three to eight feet in length, and respectively for fluid severing a root system and for industrial vacuuming, can be weigh from 10 to 20 pounds. In contrast, the tree spade can weigh several tons.

In some implementations, precision sculpting of a root ball to a specific topography is desirable for fluid severing of the plant's root system, thereby producing accurate and health promoting outcomes. Fluidized root system severing gives fine depth control. By moving the high pressure jet of fluid and by varying the time the fluid jet stays in place, a positive pressure wand operator can control the cutting depth.

The root ball can be sculpted by a positive pressure wand operator so as to cause the plant material above-the-ground to progressively lean away from an above the ground structure as the root ball is being sculpted and the plant material is becoming unstable where it grows. As such, damage to adjacent, proximal and nearby above-the-ground objects can be avoided as the root ball of the plant material (e.g.; large trees) is being detached from the lower portions of its root system.

When fluid severing of a root system is combined with intermittent or simultaneous industrial vacuuming of the resultant slurry or lose soil around the progressively severed root system, no rubble or piled up soil is left. As such, there is no waster from the process that must be removed by shovel or by some other method. After the plant material and its root ball are removed, the resultant hole in the ground can be filled by pumping back into the resultant hole the industrially vacuumed mud or slurry.

Seasonal constraints, in some implementations, are not problematic with fluid severing of a root system. When the cutting fluid is a liquid, the liquid can be heated when the ambient temperature can be below the freezing point of the fluid, and the heated fluid jetting penetrates even permafrost soil to sever root systems' ancillary structure in the course of the removal of the plant.

In some implementations, an abrasive can be included in the fluid. Such abrasives include, but are not limited to gravel, sand, garnet, and pebbles.

For a faster sculpting of a root ball, where the fluid is a liquid such as water, the fluid can be processed to include an innumerable number of tiny voids or cavities. The liquid can then be subjected to rapid and intense pressure changes so as to instantaneously collapse the tiny voids or cavities, such as by subjecting the water by ultrasonic radiation. The instantaneous collapse of the tiny voids or cavities causes a cavitation effect that increases the force with which the roots of the root system are severed. The formation and instantaneous collapse of innumerable tiny voids or cavities within a liquid subjected to rapid and intense pressure changes. Cavitation produced by ultrasonic radiation can thereby be used to effect violent localized agitation.

A high pressure pump for ejected water and an industrial vacuum source to remove the resultant mud can both be mounted upon a land vehicle for transporting same proximal the location of the plant material that is to be removed for transplanting. The land vehicle can also be used to transport the plant material to the different location where it is to be transplanted.

Wastewater filtration, pH adjustment and noise abatement (muffling) systems can be included with positive and negative fluid pressure sources to reduce environmental impact, thereby presenting an environmentally friendliness relative to reducing noise as well as flying dust and debris.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Any method of sculpting a root ball from the root system of a plant and its surrounding soil using a fluid under pressure to severe roots of the root system.

2. The method as defined in claim 1, wherein the fluid under pressure is ejected from a nozzle at the end of a manually directed wand.

3. The method as defined in claim 1, further comprising, with the sculpting, removing soil adjacent the root ball being sculpted.

4. The method as defined in claim 3, wherein the removing comprises vacuuming.

5. The method as defined in claim 4, wherein the vacuuming using an intake at the end of a manually directed wand.

6. The method as defined in claim 4, wherein the vacuuming is intermittent or continuous with the sculpting.

7. The method as defined in claim 4, wherein the vacuuming comprises forming a void between the root ball being sculpted and the soil surrounding the root ball being sculpted.

8. The method as defined in claim 1, wherein the fluid comprises a liquid.

9. The method as defined in claim 8, further comprising, with the sculpting, vacuuming slurry adjacent the root ball being sculpted, wherein the slurry is formed by the liquid and the surrounding soil of the root system.

10. The method as defined in claim 8, wherein the liquid comprises water and an additive entrained in the water that is selected from the group consisting of a solid material, a root cauterizing agent, a plant nutrient, a fertilizer, and combinations thereof.

11. The method as defined in claim 8, wherein:
the liquid comprises water and a plurality of voids or cavities within the water; and
the severing of the roots of the root system further comprises producing a cavitation effect with the fluid under pressure by collapsing the plurality of voids or cavities by pressure changes.

12. The method as defined in claim 1, wherein the fluid comprises a gas.

13. The method as defined in claim 12, wherein the gas further comprises an additive entrained in the gas and selected from the group consisting of a solid material, a liquid, a root cauterizing agent, a plant nutrient, a fertilizer, and combinations thereof.

14. The method as defined in claim 1, wherein the fluid has a pressure in a range from about one thousand pounds per square inch (psi) to about sixty thousand psi.

15. The method as defined in claim 14, wherein the fluid is a liquid having a flow in a range from about one gallon per minute (gpm) to about seventy two gpm.

16. The method as defined in claim 1, wherein the plant is selected from the group consisting of a deciduous tree, a cactus, an evergreen tree, a palm tree, and a shrub with an elongate root ball being sculpted with a topography such that the width of the elongate root ball is substantially less than the length of the elongate root ball.

17. A method of removing a plant for transplanting comprising root ball formation by ejecting water under pressure into the soil and root system of the plant to sever roots thereof.

18. The method as defined in claim 17, further comprising removing mud adjacent the root ball being formed, wherein the mud comprises the water under pressure and the soil surrounding the root system of the plant.

19. The method as defined in claim 18, wherein the removing comprises vacuuming the mud.

20. The method as defined in claim 19, wherein, with the formation of the root ball, the vacuuming is selected from the group consisting of:
intermittent vacuuming of the mud;
continuous vacuuming of the mud; and
combinations thereof.

21. The method as defined in claim 19, wherein the vacuuming comprises forming a void between the root ball being formed and the soil surrounding the root ball being formed.

22. The method as defined in claim 17, wherein the water further comprises an additive entrained in the water and selected from the group consisting of a solid material, a root cauterizing agent, a plant nutrient, a fertilizer, and combinations thereof.

23. The method as defined in claim 17, wherein the pressure is in a range from about one thousand psi to about sixty thousand psi.

24. The method as defined in claim 23, wherein the water has a flow in a range from about one gpm to about seventy two gpm.

25. The method as defined in claim 17, wherein the plant is selected from the group consisting of a deciduous tree, a cactus, an evergreen tree, a palm tree, and a shrub with an elongate root ball being sculpted with a topography such that the width of the elongate root ball is substantially less than the length of the elongate root ball.

26. The method as defined in claim 25, further comprising, after formation of the approximate semi-cylindrical root ball, removing the shrub with its approximate semi-cylindrical root ball intact from the ground.

27. A method of removing plant material for transplant comprising ejecting water under pressure from a first hand held wand into soil surrounding the plant material to form mud while using a second hand held wand to vacuum the mud as a root ball is sculpted with the first hand held wand by the water under pressure sufficient to sever the roots of the roots system of the plant material.

28. The method as defined in claim 27, wherein:
the first and second wands are in fluid communication with respective positive and negative pressure sources; and
each said positive and negative pressure sources are on a portable platform for transporting same proximal the location of the plant material.

29. The method as defined in claim 27, wherein the root ball is sculpted so as to cause the plant material above the ground to lean away from an above the ground object as the root ball is being sculpted.

30. The method as defined in claim 27, wherein the pressure is in a range from about one thousand psi to about sixty thousand psi.

31. The method as defined in claim 30, wherein the water has a flow in a range from about one gpm to about seventy two gpm.

32. The method as defined in claim 27, wherein the plant is selected from the group consisting of a deciduous tree, a cactus, an evergreen tree, a palm tree, and a shrub with an elongate root ball being sculpted with a topography such that the width of the elongate root ball is substantially less than the length of the elongate root ball.

33. The method as defined in claim 32, further comprising, after formation of the elongate root ball, removing the shrub from the ground with its elongate root ball intact.

34. For a land vehicle including positive and negative pressure sources in fluid communication with respective positive and negative wands, a method comprising:
transporting, using the land vehicle, the positive and negative pressure sources with their respective positive and negative wands to a plant planted in surrounding soil;
ejecting water with the positive pressure source from the positive wand into the soil surrounding the plant to:
form mud; and
sculpt a root ball from a root system of the plant by severing the roots of the root system of the plant in the surrounding soil;
vacuuming mud with the negative pressure source into the wand as a root ball is sculpted; and
removing the plant with its attached root ball from a hole in the surrounding soil formed by the ejecting and the vacuuming.

35. The method as defined in claim 34, wherein the plant is selected from the group consisting of a deciduous tree, a cactus, an evergreen tree, a palm tree, and a shrub with an elongate root ball being sculpted with a topography such that the width of the elongate root ball is substantially less than the length of the elongate root ball.
